(19) United States
(12) Patent Application Publication
(10) Pub. No.: US 2010/0307722 A1
(43) Pub. Date: Dec. 9, 2010

(54) HEAT TRANSPORT DEVICE AND METHOD FOR MANUFACTURING THE SAME

(75) Inventors: Hiroyuki Ryoson, Kanagawa (JP); Hiroto Kasai, Tokyo (JP); Koji Hirata, Miyagi (JP)

Correspondence Address: SNR DENTON US LLP, P.O. BOX 061080, CHICAGO, IL, 60606-1080, US

(73) Assignee: SONY CORPORATION, Tokyo (JP)

(21) Appl. No.: 12/792,347

(22) Filed: Jun. 2, 2010

(30) Foreign Application Priority Data
Jun. 9, 2009 (JP) 2009-138356

(51) Int. Cl. F28D 15/00; B23K 31/02

(52) U.S. Cl. 165/104.26; 228/265

(57) ABSTRACT

A method of manufacturing a heat transport device including the steps of stacking a first plate, a capillary member, and a second plate by interposing the capillary member between the first plate and the second plate, the first plate and the second plate constituting a container of a heat transport device configured to transport heat using phase change in a working fluid; and diffusion-bonding the first plate and the second plate while deforming the second plate to create an internal space in the container for storing the capillary member.

### BACKGROUND OF THE INVENTION

1. Field of the Invention

The present invention relates to a heat transport device that transports heat using phase change of a working fluid and a manufacturing method of the heat transport device.

2. Description of the Related Art

Plate-type heat pipes are widely used as devices for cooling heat sources, such as central processing unit (CPUs). Such a plate-type heat pipe has a sealed housing. Operating fluid and a capillary structure are disposed inside the housing. A CPU or the like is cooled by phase change in the operating fluid disposed inside the housing.

For example, in Japanese Unexamined Patent Application Publication 2006-140435 describes a heat spreader that employs the principle of a heat pipe. This heat spreader has a housing that includes an upper cover and a lower cover. The upper cover and the lower cover are each formed by pressing a copper sheet and forming protrusion on the inner side of the circumference of the upper cover. By diffusion-bonding the pressed upper and lower covers, the housing is formed, and the inner side of the protrusion in the upper cover forms an inner space in the housing (for example refer to paragraphs [0012] and [0021] and FIG. 3 in Japanese Unexamined Patent Application Publication 2006-140435).

### SUMMARY OF THE INVENTION

With the heat spreader described in Japanese Unexamined Patent Application Publication 2006-140435, to fabricate a housing, a step of processing upper and lower covers and a step of diffusion-bonding the upper and lower covers have to be performed separately. Therefore, time and cost is necessary for housing fabrication. When the shape of the heat spreader to be manufactured is changed, the processing of the upper and lower covers is also changed appropriately. When a die for pressing is to be changed, time and cost is necessary for preparation of a new die.

It is desirable to provide a method of manufacturing a heat transport device and a heat transport device those allow fabrication of a container in fewer steps and with less time and cost.

A method of manufacturing a heat transport device according to an embodiment of the present invention includes the steps of stacking a first plate, a capillary member, and a second plate by interposing the capillary member between the first plate and the second plate, the first plate and the second plate constituting a container of a heat transport device configured to transport heat using phase change in a working fluid.

The first plate and the second plate are diffusion-bonding while deforming the second plate to create an internal space in the container for storing the capillary member.

During fabrication of the container of the heat transport device, since deforming of the second plate for creating the inner space in the container accommodating the capillary member is performed simultaneously with diffusion-bonding of the first and second plates, the container can be fabricated in fewer steps and with less time and cost.

The capillary member may be disposed along the outer circumference of the container. In such a case, the stacking may include disposing a wire-type spacer between the first plate and the second plate along the outer circumference of the capillary member. Moreover, in the diffusion-bonding, the first plate and the second plate may be diffusion-bonded while deforming the second plate by applying pressure to the second plate along the outer circumference of the spacer.

The inner space having a predetermined volume is reliably formed by the spacer. Since the capillary member surrounding the outer circumference of the container is disposed in the internal space in the container, the capillary member occupies a large proportion of the internal space in the container. In this way, a capillary force due to the capillary member is sufficiently applied to the working fluid in the internal space. Moreover, the spacer prevents deformation of the internal space in the fabricated container.

A break may be formed in the spacer. In such a case, the working fluid may be injected into the internal space of the container through the break in the spacer after the diffusion-bonding.

When disposing the spacer having the break, the spacer can be easily disposed by, for example, providing one spacer along the outer circumference of the capillary member. The working fluid is injected into the internal space in the container through this break.

In the diffusion-bonding, the first plate and the second plate may be diffusion-bonded while deforming the second plate by applying pressure to the second plate so that the outline of the container is fabricated to have the predetermined shape. In such a case, the container may be fabricated by cutting out the predetermined shape from the first plate and the second plate after the diffusion-bonding.

For example, when the outline of the container to be fabricated is modified, the second plate may be deformed in accordance with the modification. In other words, with the manufacturing method according to this embodiment, a container having a predetermined outline can be fabricated.

In the stacking, the first plate, the capillary member, and the second plate may be stacked on a flat surface of a first jig. In such a case, in the diffusion-bonding, the first plate and the second plate may be diffusion-bonded while deforming the second plate with a second jig having a depression with an opening having the same shape as the outline of the container.

For example, when the outline of the container to be fabricated is modified, the second jig may be modified in accordance with the modification. The second jig is fabricated in less time and with a lower cost compared with fabricating a die used in press work.

A heat transport device according to an embodiment of the present invention includes a working fluid, a capillary member, a wire-type spacer, and a container. The working fluid configured to transport heat by changing phases. The capillary member is configured to apply capillary force to the working fluid.

The spacer has an outer circumference and surrounds the capillary member.

The container includes an internal space, a first plate, and the first plate.

The working fluid, the capillary member, and the spacer are disposed in the internal space.

The second plate is diffusion-bonded while being deformed to create the internal space by pressure applied along the outer circumference of the spacer.

As described above, according to an embodiment of the present invention, the container can be fabricated in fewer steps and with less time and cost.

### BRIEF DESCRIPTION OF THE DRAWINGS

FIG. 1 is a perspective view illustrating a heat transport device according to a first embodiment of the present invention.

FIG. 2 is sectional view taken along line II-II in the lateral direction of a heat transport device illustrated in FIG. 1.

FIG. 3 is an exploded perspective view of the heat transport device illustrated in FIG. 1.

FIGS. 4A and 4B illustrate a manufacturing method of the heat transport device illustrated in FIG. 1.

FIG. 5 is a perspective view of a heat transport device according to a second embodiment of the present invention.

FIGS. 6A to 6C illustrate a method of manufacturing the heat transport device, which is illustrated in FIG. 5.

FIGS. 7A to 7C illustrate is a method of manufacturing the heat transport device according to a third embodiment of the present invention.

FIGS. 8A and 8B are sectional views taken along line VIII-VIII of the heat transport device in the steps illustrated in FIGS. 7A to 7C.

FIGS. 9A and 9B illustrate a part where a break is formed in the spacer illustrated in FIGS. 7A to 7C.

FIG. 10 illustrates a modification of the spacer in the heat transport device according to the third embodiment illustrated in FIGS. 8A and 8B.

FIG. 11 is a perspective view of a second jig used in the method of manufacturing the heat transport device according to the second embodiment.

### DESCRIPTION OF THE PREFERRED EMBODIMENTS

Embodiments of the present invention will be described below with reference to the drawings.

### First Embodiment

### Configuration of Heat Transport Device

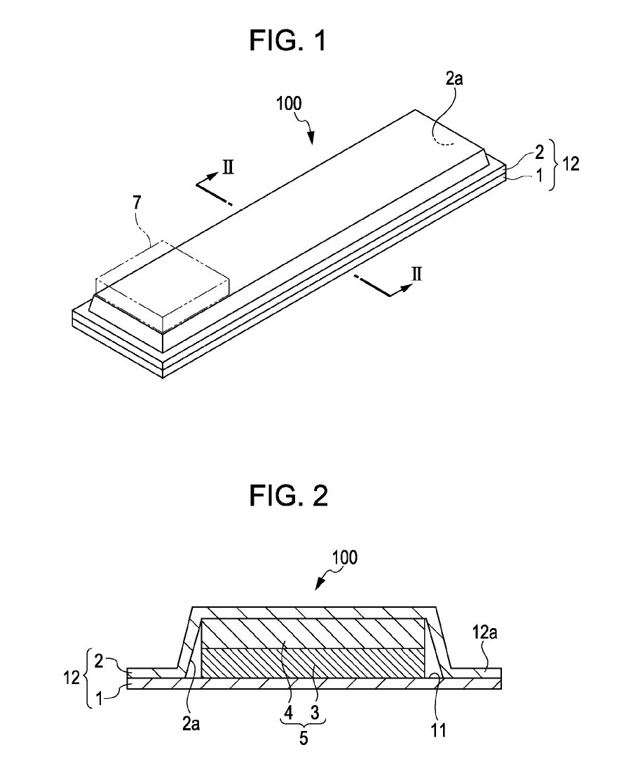

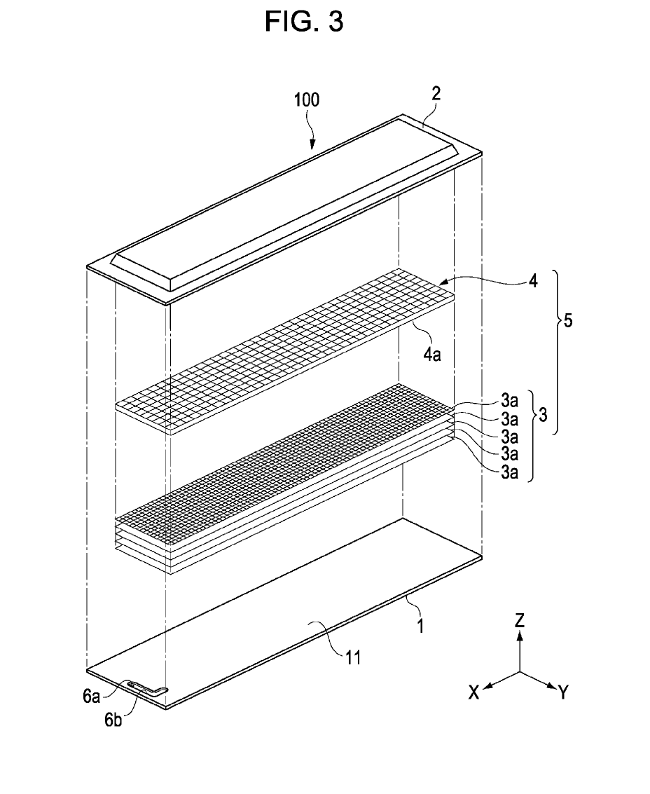

FIG. 1 is a perspective view illustrating a heat transport device according to a first embodiment of the present invention. FIG. 2 is sectional view taken along line II-II in the lateral direction of a heat transport device 100 illustrated in FIG. 1. FIG. 3 is an exploded perspective view of the heat transport device 100.

The heat transport device 100 includes a container 12 constituted of a lower plate 1 and a dish-shaped upper plate 2. A depression 2a in the upper plate 2 creates an internal space in the container 12 (hereinafter, this internal space is referred to as an internal space 2a). A working fluid (not shown) that transports heat through phase change sealed in the internal space 2a. The internal space 2a accommodates a capillary member 5 that applies a capillary force to the working fluid. In this embodiment, the lower plate 1, the upper plate 2, and the capillary member 5 are shaped as rectangles.

The working fluid is injected into the internal space 2a through an injection port 6a formed in an inner surface 11 of the lower plate 1 and an injection path 6b, which is an L-shaped grooved communicating with the injection port 6a. The injection port 6a is formed through the lower plate 1. The injection path 6b is connected to the internal space 2a. The injection path 6b may be formed by end-mill processing, laser processing, pressing, or microfabrication used in semiconductor production, such as photolithography or half etching. The injection port 6a and the injection path 6b are sealed by, for example, swaging after the working fluid is injected into the internal space 2a.

The lower plate 1 and the upper plate 2 are made of metal, such as copper, aluminum, or stainless steel, or a highly heat-conductive material, such as carbon nanomaterial. The working fluid is, for example, pure water, ethanol, methanol, acetone, isopropyl alcohol, hydrochlorofluorocarbon, or ammonia.

The capillary member 5 is constituted of a first mesh layer 3 and a second mesh layer 4. The first mesh layer 3 is disposed on an inner surface 11 of the lower plate 1, and the second mesh layer 4 is stacked on the first mesh layer 3.

As illustrated in FIG. 3, the first mesh layer 3 is formed by stacking mesh members 3a, which are each formed of weaved thin metal lines. The second mesh layer 4 is formed of a single mesh member 4a. The mesh size of the mesh members 3a is smaller than the mesh size of the mesh member 4a. Thus, when the heat transport device 100 is not operating, the working fluid is mostly attracted to the first mesh layer 3, which has a strong capillary force.

The capillary member 5 may be formed of a material other than mesh layers. For example, the capillary member 5 may be formed of a bundle of wires or a structure of sintered metal powder. In addition, the capillary member 5 may be shaped as stripes, a mesh, or grooves formed by etching.

### Operation of Heat Transport Device

The operation of the heat transport device 100 will be described. As illustrated in FIG. 1, for example, a heat source 7 is thermally connected to one side in the longitudinal direction of the upper plate 2 of the heat transport device 100. Here, “thermally connected” means direct connection or connection through a thermally conductive member or a thermally conductive sheet, which are not illustrated in the drawing. The heat source 7 is typically an integrated circuit (IC) of a CPU but instead may be a light source, such as a semiconductor laser or a light emitting diode (LED).

In the internal space 2a in the container 12, the working fluid in a liquid phase receives heat from the heat source 7 and is vaporized. The working fluid in a gas phase moves mainly through the second mesh layer 4 to a side opposite to the side connected to the heat source 7 in the longitudinal direction of the upper plate 2 and releases heat as a result of condensation. The condensed working fluid now in the liquid phase receives the capillary force of the first mesh layer 3 and moves toward the side connected to the heat source 7. Then, the liquid-phase working fluid receives heat again from the heat source 7 and is vaporized. By repeating this cycle, the heat source 7 is cooled.

FIG. 1 illustrates an example in which the heat source 7 is disposed on the upper plate 2, which is the side of the heat transport device 100 closer to the gas phase, i.e., the side closer to the second mesh layer 4. However, since a thin plate constitutes the heat transport device 100, even, for example, when the heat source 7 is disposed on the lower plate 1, which is the side of the heat transport device 100 closer to the liquid phase, i.e., the side closer to the first mesh layer 3, high heat transport ability is achieved.

### Manufacturing Method of Heat Transport Device

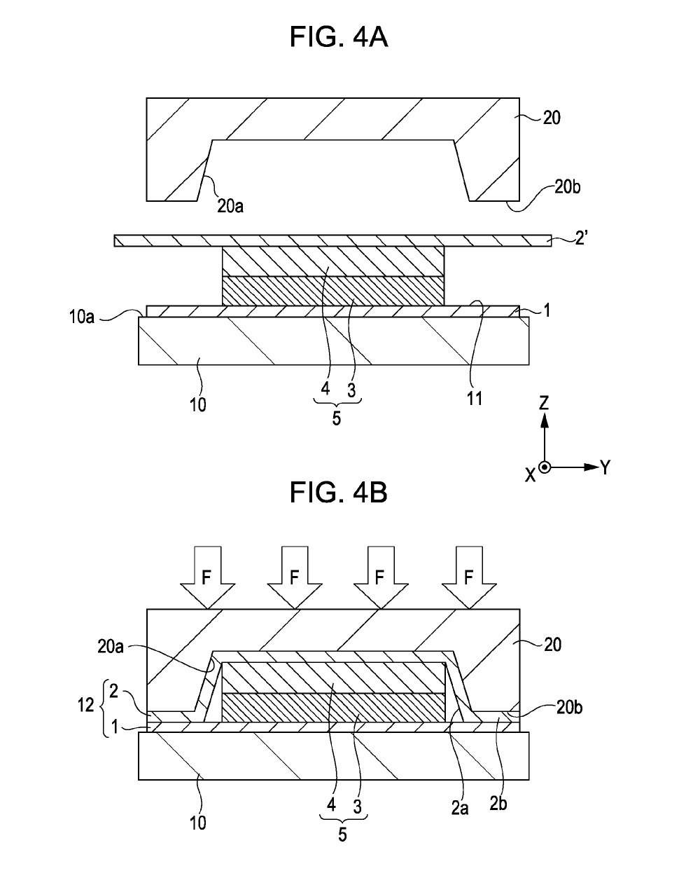

FIGS. 4A and 4B illustrate a method of manufacturing the heat transport device 100. As illustrated in FIG. 4A, the lower plate 1 is placed on a flat surface 10a of a first jig 10, and the capillary member 5 is placed on the inner surface 11 of the lower plate 1. A flat plate 2′, which constitutes the upper plate 2, is placed on the capillary member 5.

A second jig 20 is disposed above the flat plate 2′. The second jig 20 has a depression 20a. A plan view of the depression 20a (when viewed in the Z direction in FIGS. 4A and 4B), i.e., the shape of the opening of the depression 20a, is the same shape as the outline of the container 12 of the heat transport device 100. The periphery of the depression 20a constitutes a pressing part 20b.

As illustrated in FIG. 4B, a total load F is applied to the second jig 20 in the direction from the flat plate 2′ to the lower plate 1 (Z direction in FIGS. 4A and 4B) to apply pressure from the second jig 20 to the flat plate 2′. Through this, an outer-circumferential region 2b of the flat plate 2′ is pressed by the pressing part 20b of the second jig 20 and is diffusion-bonded with the lower plate 1.

Since this diffusion-bonding is performed under a high-temperature condition, e.g., approximately 900° C., the flat plate 2′ pressed by the second jig 20 is softened and deformed. Since the shape of the opening of the depression 20a of the second jig 20 is the same as the outline of the container 12, the flat plate 2′ constitutes the upper plate 2 having the depression 2a, which constitutes the outline of the container 12. The capillary member 5 is disposed in the depression 2a of the upper plate 2. This capillary member 5 prevents the container 12 from being crushed during the diffusion-bonding and creates the internal space 2a (depression 2a). In other words, in the diffusion-bonding, the flat plate 2′ is deformed by the second jig 20 to form the upper plate 2, and the upper plate 2 is diffusion-bonded with the lower plate 1.

In this way, during the formation of the container 12 of the heat transport device 100, a deforming of the flat plate 2′ to form the upper plate 2 so as to create the internal space 2a in the container 12 for accommodating the capillary member 5 is performed during the diffusion-bonding where the lower plate 1 and the upper plate 2 are bonded. In this way, the container 12 can be formed in a short amount of time and with low cost through fewer steps.

The depth of the depression 20a of the second jig 20 and the thickness of the capillary member 5 may be set appropriately, and the capillary member 5 may be diffusion-bonded to both the lower plate 1 and the upper plate 2 in the diffusion-bonding. For example, the thickness of the capillary member 5 may be greater than the depth of the depression 20a. In this way, the capillary member 5 may be compressed in the diffusion-bonding, and the capillary member 5 may be diffusion-bonded to both the lower plate 1 and the upper plate 2 by stress of the compressed capillary member 5.

The size of the flat plate 2′, which is illustrated in FIG. 4A, may be set appropriately. The flat plate 2′ is deformed in the diffusion-bonding and constitutes the upper plate 2 having the depression 2a. Therefore, in this embodiment, the flat plate 2′ is larger than the lower plate 1 by the depth of the depression 2a. The size of the flat plate 2′, however, is set appropriately in accordance with the entire thickness of the container 12, the thickness of the sidewall of the upper plate 2 to be formed, and so on.

The shape of the second jig 20 may also be set appropriately. For example, the second jig 20 may not have the depression 20a and may only have the pressing part 20b that presses the outer-circumferential region 2b of the flat plate 2′. In such a case, the pressing part 20b is shaped as a ring that matches the outline of the container 12 to be fabricated. In such a case also, since the capillary member 5 is placed on the lower plate 1, the flat plate 2′ is deformed to form the upper plate 2 having the internal space 2a (depression 2a) where the capillary member 5 is disposed. In addition, the upper plate 2 and the lower plate 1 are diffusion-bonded. The load applied to the second jig 20 may not be the total load F but a load applied only to the pressing part 20b.

### Second Embodiment

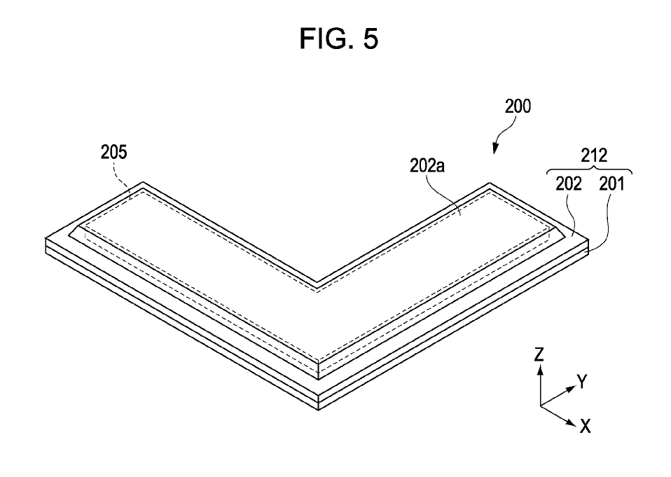

FIG. 5 is a perspective view of a heat transport device according to a second embodiment of the present invention. In the following, descriptions of structures and operations that are the same as those of the heat transport device 100 in the above-described embodiment will be omitted or simplified.

A heat transport device 200 according to the second embodiment differs from the heat transport device 100 according to the first embodiment in that the outline of a container 212 is L-shaped. An upper plate 202 of the heat transport device 200 is dish-shaped and has a depression 202a in the inner surface side. The depression 202a constitutes an internal space 202a in the container 212. An L-shaped capillary member 205 is disposed in the internal space 202a along the outer circumference of the container 212 (dotted line in FIG. 5).

### Method of Manufacturing Heat Transport Device

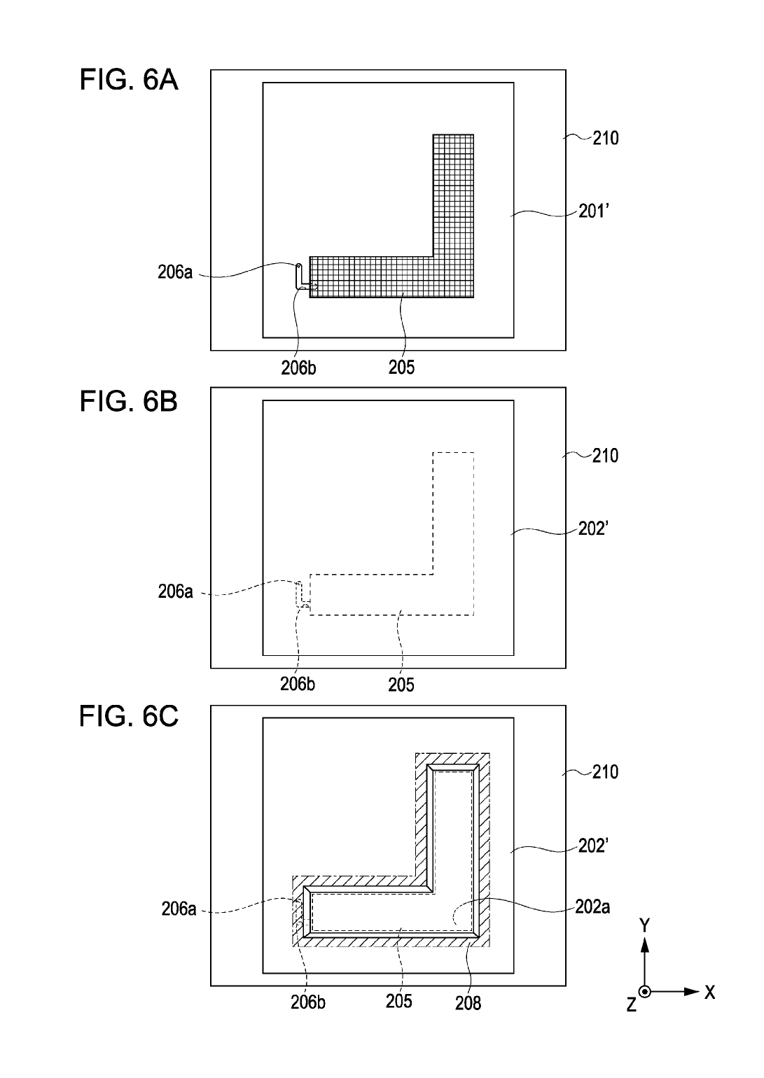

FIGS. 6A to 6C illustrate a method of manufacturing the heat transport device 200 in the thickness direction of the heat transport device 200.

As shown in FIG. 6A, a flat plate 201′ is placed on a first jig 210. The flat plate 201′ constitutes a lower plate 201, which is illustrated in FIG. 5. In FIG. 6A, the first jig 210 is shaped as a rectangle. The shape of the first jig 210, however, is not limited. The shape of the flat plate 201′ is also not limited to a rectangle and may be any other shape so long as the lower plate 201 can be formed in the diffusion-bonding described below.

An injection port 206a and an injection path 206b are formed in the flat plate 201′. The L-shaped capillary member 205 is placed on the flat plate 201′ in alignment with the positions of the injection port 206a and injection path 206b.

As illustrated in FIG. 6B, a rectangular flat plate 202′ is placed on the capillary member 205. This flat plate 202′ constitutes the upper plate 202. In this embodiment, the flat plate 202′ and the flat plate 201′ are both shaped as rectangles. However, the shapes of the flat plate 202′ and the flat plate 201′ are not limited so long as the upper plate 202 can be formed in the diffusion-bonding described below. In FIG. 6B, the injection port 206a and the injection path 206b formed in the flat plate 201′ and the capillary member 5 placed on the flat plate 201′ are represented by dotted lines.

In the step illustrated in FIG. 6C, a second jig 220, which is illustrated in FIG. 11, applies pressure to the flat plate 202′ from above the flat plate 202′ in the vertical direction. As illustrated in FIG. 11, the second jig 220 has a protruding pressing part 220b that presses the flat plate 201′ and the flat plate 202′ when these plates are bonded.

The outline of the pressing part 220b is the same shape as the outline of the container 212. The inner section of the pressing part 220b constitutes a depression 220a. In other words, similar to the first embodiment, the second jig 220 is provided with the depression 220a having an opening that is the shape as the outline of the container 212. In this embodiment, the opening of the depression 220a is L-shaped. The second jig 220 forms, in the flat plate 202′, an L-shaped depression 202a where the capillary member 205 is disposed and diffusion-bonds the flat plate 201′ and the flat plate 202′. When viewed from the above, the depression 202a is a projection.

In FIG. 6C, a bonded region 208 where the flat plate 201′ and the flat plate 202′ are diffusion-bonded is represented by the hatched area. The size of the bonded region 208 is set in accordance with the size of the pressing part 220b of the second jig 220. The injection port 206a and the injection path 206b, which are described above, are included inside the bonded region 208.

In the bonded region 208, the flat plate 201′ and the flat plate 202′ are cut out to constitute the heat transport device 200, which is illustrated in FIG. 5. The cutout flat plate 201′ constitutes the lower plate 201, whereas the cutout flat plate 202′ constitutes the upper plate 202. For cutting out the flat plate 201′ and the flat plate 202′, for example, a laser cutter or a punching die is used. The flat plate 201′ and the flat plate 202′ may instead be cut out using wire electrical discharge machining (wire cutting).

A case in which the outline of the container 212 is changed from an L shape to some other shape will be described below. In such a case, in the manufacturing method according to this embodiment, the flat plate 201′ and the flat plate 202′ may be diffusion-bonded while deforming the flat plate 202′ into the selected shape in the diffusion-bonding. In other words, in the manufacturing method according to this embodiment, the container 212 having a predetermined outline can be formed by deforming the flat plate 202′ into having a predetermined outline. In such a case, by replacing the second jig 220 with a new second jig with a depression having an opening of a predetermined outline, the flat plate 202′ can be deformed into having the predetermined outline in the diffusion-bonding.

For example to deform the flat plate 202′ by press work or die machining, such as squeezing, in normal temperature of approximately 25° C., an extremely large load of several tens of tons should be applied to the flat plate 202′. An apparatus that generates such a large load for the processing of the flat plate 202′ is expensive, and thus the facility cost will increase. In this embodiment, however, since the flat plate 202′ is softened under high temperature, the large load mentioned above may not be necessary for deforming the flat plate 202′ and the facility cost can be suppressed.

When the container 212 is fabricated by die machining, it is necessary to fabricate a new die when the outline of the container 212 to be fabricated is changed. Since the die is made of material that is harder than the flat plate 202′ and that does not deform when it receives a large load, large time and cost are necessary for fabricating a new die.

In contrast, the second jig 220, which is the die to be used in the manufacturing method according to this embodiment, may be made of a material having a high melting temperature so that it is not softened under high temperature during the diffusion-bonding, and thus the same level of hardness as the above-described die is not necessary. Therefore, the second jig 220 may be made of, for example, inexpensive stainless steel or iron. In other words, the second jig 220 can be fabricated in less time and with a lower cost compared with fabricating a die used in press work.

### Third Embodiment

A heat transport device and a manufacturing method thereof according to a third embodiment of the present invention will be described below. The heat transport device according to this embodiment has a container with an L-shaped outline, which is similar to the heat transport device 200 according to the second embodiment. An L-shaped capillary member and a wire-type spacer surrounding the outer circumference of the capillary member 5 are disposed in an internal space in the container.

### Method of Manufacturing Heat Transport Device

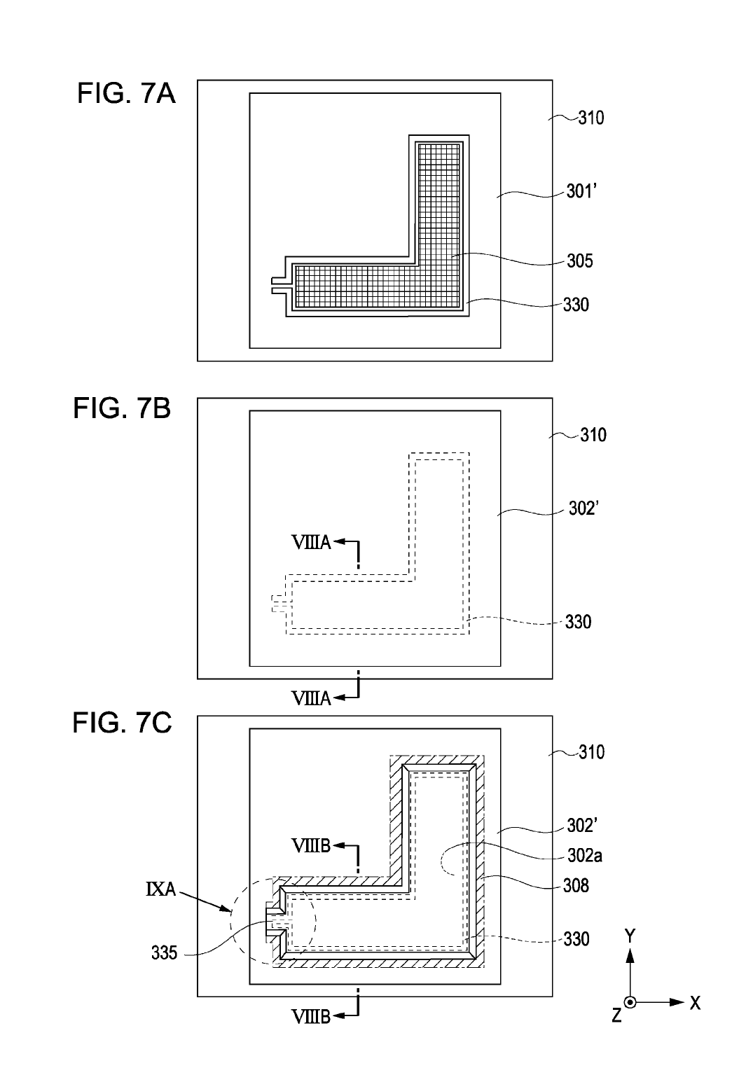

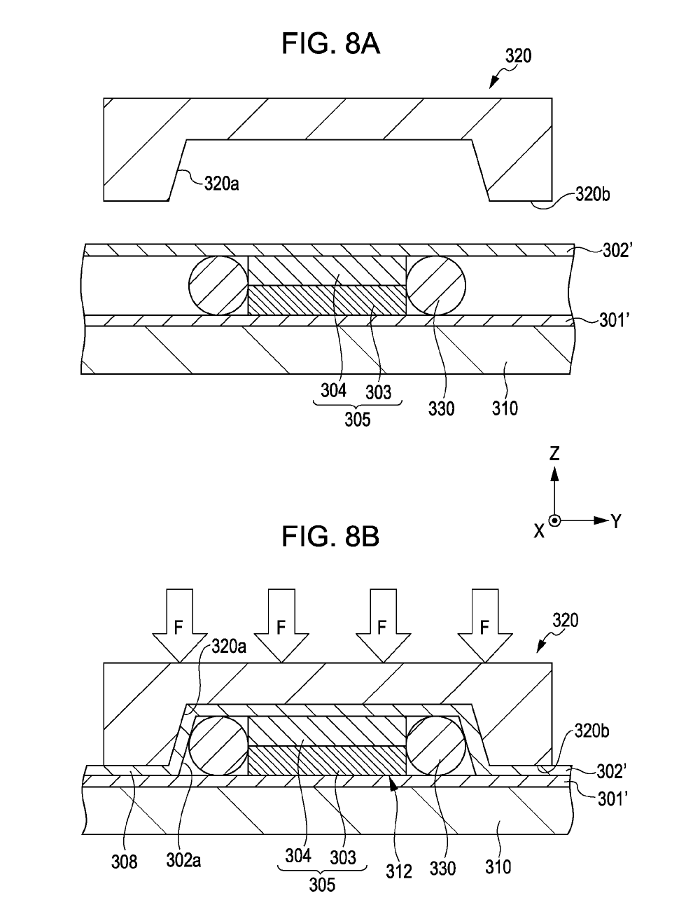

FIGS. 7A to 7C illustrate a manufacturing method of a heat transport device according to this embodiment. FIGS. 8A and 8B are sectional views taken along line VIII-VIII of the heat transport device in a process illustrated in FIGS. 7A to 7C.

As illustrated in FIG. 7A, a flat plate 301′, which constitutes a lower plate, is placed on a first jig 310. An L-shaped capillary member 305 is placed on the flat plate 301′. In the manufacturing method according to this embodiment, a wire-type spacer 330 surrounding the outer circumference of the capillary member 305 is disposed on the flat plate 301′. For example, a single wire made of a metal, such as copper, is used as the spacer 330. The diameter of the cross-section of the spacer 330 (cross-section of the wire) is set substantially equal to the desired thickness of the internal space in the container.

As illustrated in FIG. 7B, a flat plate 302′, which constitutes an upper plate, is placed on the capillary member 305 and the spacer 330. As illustrated in FIG. 8A, a second jig 320 is disposed above the flat plate 302′ placed on the capillary member 305 and the spacer 330. To simplify descriptions, the second jig 320 is omitted in FIGS. 7A to 7C. Similarly, in FIGS. 7B and 7C, only the spacer 330 interposed between the flat plate 301′ and the flat plate 302′ is represented by dotted lines, and the capillary member 305 is omitted.

The second jig 320 has a depression 320a. An opening of the depression 320a is L-shaped, which is the same as the outline of a container 312. The periphery of the depression 320a constitutes a pressing part 320b.

As illustrated in FIGS. 7C and 8B, the second jig 320 applies pressure to the flat plate 302′ from above the flat plate 302′ in the vertical direction. The pressing part 320b of the second jig 320 presses an area 308 along the outer circumference of the spacer 330. This area 308 constitutes a bonding region 303. In this way, a depression 302a with an L-shaped outline, where the capillary member 305 and the spacer 330 are disposed, is created in the flat plate 302′ and the flat plate 301′ and the flat plate 302′ are diffusion-bonded. As illustrated in FIG. 7C, pressure is not applied to the flat plate 302′ at the position of a break 335 in the spacer 330. The position of the break 335 will be described below.

In the manufacturing method according to this embodiment, the spacer 330 reliably forms an internal space 302a having a predetermined volume. In this way, a capillary force due to the capillary member 305 is sufficiently applied to a working fluid in the internal space 302a. Since the internal space 302a is reliably formed, for example, an increase in the flow path resistance due to a deformation in the capillary member 305 against the moving gaseous working fluid can be prevented. In other words, by providing the spacer 330 in the internal space 302a, the function of the capillary member 305 in relation to heat transport is sufficiently applied. Furthermore, the spacer 330 prevents the internal space 302a from being deformed by, for example, an external force applied to the manufactured heat transport device.

A ring-shaped spacer may be disposed around the capillary member 305. In such a case, formation of the spacer into a ring shape should be provided. Moreover, the spacer 330 (see FIG. 7C) having the break 335 may be disposed as in this embodiment. In such a case, by disposing the spacer 330 formed of one wire along the outer circumference of the capillary member 305, the spacer 330 can be easily provided even when, for example, the shape of the capillary member 305 is changed. As described below, the working fluid may be injected into the internal space 302a in the container 312 through the break 335 in the spacer 330.

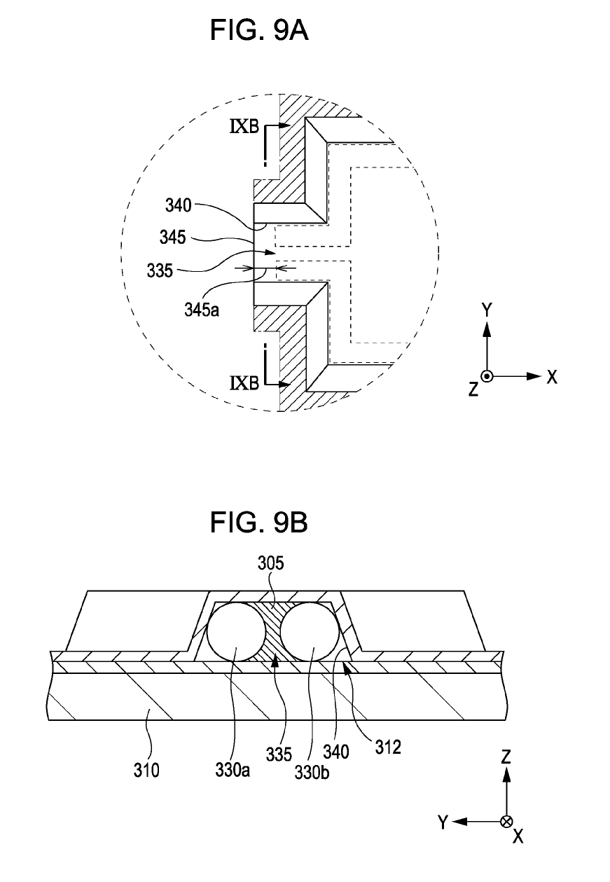

FIGS. 9A and 9B illustrate the position of the break 335 in the spacer 330 illustrated in FIGS. 7A to 7C. FIG. 9A is an exploded view of the area indicated by the reference character IXA in FIG. 7C. FIG. 9B is a sectional view taken along line IX-IX in FIG. 9A.

In the diffusion-bonding illustrated in FIG. 7C, a hole 340 that connects the outside of the container 312 and the internal space 302a is formed at the position of the break 335 in the spacer 330. As illustrated in FIG. 9B, two ends 330a and 330b of the spacer 330 are position in the hole 340. The gap (break 335) between the two ends 330a and 330b is connected with the internal space 302a. FIG. 9B illustrates the capillary member 305 disposed in the internal space 302a between the two ends 330a and 330b. The working fluid is injected into the internal space 302a through the hole 340.

As illustrated in FIG. 9A, the two ends 330a and 330b of the spacer 330 are positioned closer to the internal space 302a in the container 312 than an opening plane 345 of the hole 340. An area 345a from the opening plane 345 to the two ends 330a and 330b is sealed after the working fluid is injected into the internal space 302a to seal the container 312. Then, in the area 308 and the area 345a pressed and bonded by the pressing part 320b of the second jig 320, the flat plates 301′ and 302′ are cut out to constitute the heat transport device according to this embodiment.

In this way, in this embodiment, the hole 340 is formed at the break 335 in the spacer 330, and the working fluid is injected into the internal space 302a through the hole 340. Thus, injection ports and injection paths are not necessary in the flat plates 301′ and 302′, as in the first and second embodiments. Furthermore, as in the second embodiment, since the capillary member 305 does not have to be placed on the flat plate 301′ in alignment with the injection port and the injection path, workability in the manufacturing of the heat transport device is improved. A plurality of breaks may be provided in the spacer.

### Modifications

The present invention is not limited to the embodiments described above, and various modifications may be made within the scope of the invention.

For example, in the embodiments described above, a capillary member formed in a shape of the outer circumference of a container is disposed in an internal space. In this way, the proportion of the volume of the capillary member to the internal space inside the container increases, and the capillary face due to the capillary member is sufficiently applied to a working fluid. In a diffusion-bonding, the container can be prevented from being crushed by a capillary force due to a failure in the formation of an inner space in the container when a flat plate constituting an upper plate is deformed.

However, the shape of the capillary member is not limited to a shape of the outer circumference of the container. If the shape of the capillary member is not a shape of the outer circumference of the container, a spacer may be provided along the outer circumference of the container such that the flat plate constituting the upper plate is appropriately deformed and bonded with a flat plate constituting a lower plate. Instead, a plurality of column etc., may be interposed between the two flat plates along the outer circumference of the container to allow a flat plate to deform appropriately.

In the embodiments described above, the capillary member is constituted of two mesh layers that act as liquid-phase and gas-phase working fluid paths. Instead, however, the capillary member may constitute a liquid-phase working fluid path, and a space between the capillary member and a sidewall in the internal space may constitute a gas-phase working fluid path.

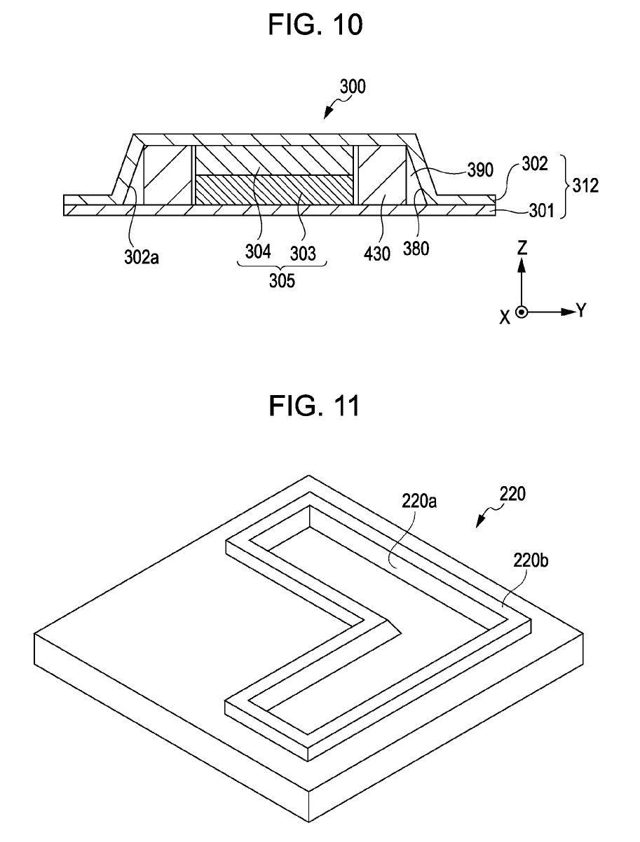

FIG. 10 illustrates a modification of the spacer 330 in the heat transport device 300 according to the third embodiment illustrated in FIGS. 8A and 8B. The cross-section of the above-described spacer 330 is circular (see FIGS. 8A and 8B). On the other hand, the cross-section of a spacer 430 illustrated in FIG. 10 is rectangular.

The spacer 430 having a rectangular cross-section is stably provided in the internal space 302a without displacement in the Y direction in FIG. 10 compared with the spacer 330 having a circular cross-section. Thus, compared with the spacer 330, the spacer 430 can reliably create an internal space 302a when the upper plate 302 is formed in the diffusion-bonding.

The spacer 430 occupies a larger proportion of an area 390 between the capillary member 305 and a sidewall 380 of the internal space 302a than the spacer 330. As described above, when the area 390 constitutes a liquid-phase working fluid path, the efficiency of heat transport by the liquid-phase working fluid is improved more when the spacer 330 occupying a smaller proportion of the area 390 is used compared to when the spacer 430 is used. In this way, the stability in creating an internal space in a container, the efficiency of heat transport by working fluid, and so on are taken into consideration to appropriately select the cross-section of a spacer.

Moreover, a bundle of thin metal lines may constitute a wire and be used as a spacer. In such a case, the bundle of metal thin lines applies a capillary force to a liquid-phase working fluid. Furthermore, a gas-phase working fluid may possibly move through the inside of the spacer.

The present application contains subject matter related to that disclosed in Japanese Priority Patent Application JP 2009-138356 filed in the Japan Patent Office on Jun. 9, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method of manufacturing a heat transport device comprising the steps of:
stacking a first plate, a capillary member, and a second plate by interposing the capillary member between the first plate and the second plate, the first plate and the second plate constituting a container of a heat transport device configured to transport heat using phase change in a working fluid; and
diffusion-bonding the first plate and the second plate while deforming the second plate to create an internal space in the container for storing the capillary member.

2. The method of manufacturing a heat transport device according to claim 1, wherein
the capillary member is disposed along the outer circumference of the container,
the stacking includes disposing a wire-type spacer between the first plate and the second plate along the outer circumference of the capillary member, and
in the diffusion-bonding, the first plate and the second plate are diffusion-bonded while deforming the second plate by applying pressure to the second plate along the outer circumference of the spacer.

3. The method of manufacturing a heat transport device according to claim 2, further comprising the step of:
injecting the working fluid into the internal space of the container through a break formed in the spacer, the working fluid being injected after the diffusion-bonding.

4. The method of manufacturing a heat transport device according to claim 1, further comprising the step of:
fabricating the container by cutting out a predetermined shape from the first plate and the second plate after the diffusion-bonding,
wherein, in the diffusion-bonding, the first plate and the second plate are diffusion-bonded while deforming the second plate by applying pressure to the second plate so that the outline of the container is fabricated to have the predetermined shape.

5. The method of manufacturing a heat transport device according to claim 4, wherein
in the stacking, the first plate, the capillary member, and the second plate are stacked on a flat surface of a first jig, and
in the diffusion-bonding, the first plate and the second plate are diffusion-bonded while deforming the second plate with a second jig having a depression with an opening having the same shape as the outline of the container.

6. A heat transport device comprising:
a working fluid configured to transport heat by changing phases;
a capillary member configured to apply capillary force to the working fluid;
a wire-type spacer having an outer circumference and surrounding the capillary member; and
a container including an internal space where the working fluid, the capillary member, and the spacer are disposed, a first plate, and a second plate diffusion-bonded to the first plate while being deformed to create the internal space by pressure applied along the outer circumference of the spacer.
